(19) United States
(12) Patent Application Publication
(10) Pub. No.: US 2013/0234862 A1
(43) Pub. Date: Sep. 12, 2013

(54) Street Light Monitoring System

(71) Applicants: Michael A. Toth, Middleburg, FL (US); J. David Lambert, Atlantic Beach, FL (US); Patrick T. Welsh, Keystone Heights, FL (US); Gerald U. Merckel, Jacksonville, FL (US); Daniel J. Cox, St. Augustine, FL (US)

(72) Inventors: Michael A. Toth, Middleburg, FL (US); J. David Lambert, Atlantic Beach, FL (US); Patrick T. Welsh, Keystone Heights, FL (US); Gerald U. Merckel, Jacksonville, FL (US); Daniel J. Cox, St. Augustine, FL (US)

(73) Assignee: UNIVERSITY OF NORTH FLORIDA BOARD OF TRUSTEES, Jacksonville, FL (US)

(21) Appl. No.: 13/588,552

(22) Filed: Aug. 17, 2012

Related U.S. Application Data
(60) Provisional application No. 61/575,364, filed on Aug. 19, 2011.

(51) Int. Cl. G08C 17/02

(52) U.S. Cl. CPC G08C 17/02
USPC 340/870.03

(57) ABSTRACT

A street light monitoring and real time data management system and methodology for collecting information from geographical distributed locations or individual sensor nodes dedicated to individual street lights of a multi-light street light system.

This application claims the benefit of U.S. Provisional Patent Application Ser. No. 61/575,364, filed Aug. 19, 2011.

### BACKGROUND OF THE INVENTION

The invention relates to a system for the monitoring of street lights whereby individual light failures are reported to a remote management center that utilizes an heuristic wireless communications network or system comprising a plurality of geographically spaced or physically separated nodes. The capabilities of each of the nodes include nearest sensor neighbor detection and recording, automatic communication route determination to a node controller and providing real time status information to the node controller. The nodes are capable of sensing, analyzing and implementing the best available communications path to other nodes and to the node controller. The node controller itself may be a sensor with additional capabilities such as communication ability to a Management Center, typically by wireless means. The node controller also contains the necessary logic to perform the control node functions.

Lighting systems are provided for streets, interstates, bridges, airports, maritime ports, parking lots and government installations for safety and security purposes. The determination of the operating characteristics of individual lights is typically done via a manual inspection. When a light is found to be non-functioning, a repair action is conducted on the light. Some newer lighting systems utilize light assemblies that incorporate an internal sensor to determine a light failure and a means to communicate the failure condition. For example, the amount of energy being consumed per unit time is an indicator of a light's proper operation. Another approach is the use of a photodiode that has self-checking circuitry to determine correct functioning with sunset or sunrise. Many lighting systems in America do not use intelligent light assemblies that can sense and report their individual light operational status. This invention provides a means to detect and report an individual light's operational characteristics without modification to the existing lighting system electrical infrastructure.

The light sensor in this invention requires no modification to the electrical infrastructure of the existing lighting system. The light sensor scavenges energy from the environment in order to operate. The sensor is mechanically attached to an existing light assembly such that the light emanating from the light can be monitored. The light sensor itself is a node in an heuristic wireless communications network. The light sensor capabilities include nearest sensor neighbor detection and recording, automatic communication route determination to a node controller and providing real time light status information to the node controller. The node controller itself is a light sensor with additional capabilities such as communication ability to a light Management Light Center, typically by wireless means. The node controller also contains the necessary logic to perform the control node functions.

The light sensor is designed with a modular architecture allowing other sensor types to be readily incorporated such as temperature and barometric pressure if desired. The light sensor utilizes fiber optic techniques to gather light and route it to a photo detector. The light is converted into an analog signal and then into a digital format for processing and reporting as appropriate. A small photovoltaic panel is utilized to capture solar energy in order to maintain an electrical charge on a lithium battery. A low power wireless communications capability provides the capability to communicate and integrate into the heuristic sensor network. In order to provide for grated reliability, availability and sustainability, additional circuits and microprocessor programs to monitor the status of the sensor itself and log any problems conditions such as low battery or analog-to-digital converter improper function.

Thus, it is one object of this invention to provide a real time data management system for collecting information from geographical distributed locations or individual sensor nodes coordinated with individual light assemblies of a street lighting system comprising:

an intelligent detection sensor that performs self-checking to insure reliability, availability and sustainability, has the ability to discover nearby or “neighbor” sensors, has the ability to discover and establish a wireless network communication path, has the ability to autonomously change the wireless network communication path, and has the ability to participate in a communication protocol for reporting measured conditions of a given sensor;

an intelligent sensor architecture that accommodates the ability to incorporate other sensor types;

a means for collecting information and for assigning unique space and/or time coordinates associated with said information, said information collected for immediate or subsequent transmission;

a communication network for transmitting said collected information;

a means for establishing a connection between said information collection means and said communication network and for initiating the transmission of said collected information instantly or at a selected time; said establishing means in communication with to said means collecting means;

a computer, coupled to said communication network, adapted to receive said collected information from said information collecting means and for transforming said collected information and associated space and/or time coordinates into an event description and/or other associated data; said computer adapted to store said event description and associated data in an event database and for accessing a reference database to generate an event summary that combines or updates said event description with a previously generated event summaries.

It is a further object to provide a system for managing the distribution of resources in response to the state of the system.

It is a further object to provide a method for obtaining and disbursing information concerning the sensed conditions.

It is a further object of the present invention to provide a means by which the status of individual lights in an existing lighting system can be automatically determined and reported without modification of the electrical infrastructure of the existing lighting system. Lighting system utility operators typically rely on periodic visual inspections to determine the status of individual lights and note those lights in need of repair. The interval between inspections can be lengthy depending on costs, availability of people and equipment thus potentially impacting security and safety.

### SUMMARY OF THE INVENTION

The present invention relates to an overall system and automatic method to detect and report on the state of each light in a lighting system without modification of the existing lighting system electrical infrastructure. More particularly, the present invention relates to an improved system for an efficient system and method for obtaining and assessing real-time operational status of individual lights in an existing lighting system dispersed over a geographical area.

In one embodiment, the invention is a street light monitoring and real time data management system and methodology for collecting information from geographical distributed locations or individual sensor nodes dedicated to individual street lights of a multi-light street light system comprising:

an intelligent detection sensor that performs self-checking to insure reliability, availability and sustainability, has the ability to discover nearby or “neighbor” sensors, has the ability to discover and establish a wireless network communication path, has the ability to autonomously change the wireless network communication path, and has the ability to participate in a communication protocol for reporting measured conditions of a given sensor;

an intelligent sensor architecture that accommodates the ability to incorporate other sensor type;

a means for collecting information and for assigning unique space and/or time coordinates associated with said information, said information collected for immediate or subsequent transmission;

a communication network for transmitting said collected information;

a means for establishing a connection between said information collection means and said communication network and for initiating the transmission of said collected information instantly or at a selected time; said establishing means in communication with to said means collecting means;

a computer, coupled to said communication network, adapted to receive said collected information from said information collecting means and for transforming said collected information and associated space and/or time coordinates into an event description and/or other associated data; said computer adapted to store said event description and associated data in an event database and for accessing a reference database to generate an event summary that combines or updates said event description with a previously generated event summaries.

Briefly, this is achieved according to the present invention by an intelligent light sensor which has the ability to periodically detect the individual light's operational characteristics. This information is recorded within the given light sensor. The light sensor also has the ability to automatically integrate itself into an heuristic wireless network for reporting the light's operational characteristics. If there are network communication difficulties, the light sensor can automatically modify its communication routing path to a control node. The light sensor is mechanically attached to the light and requires no modification of the lighting system electrical infrastructure. In the preferred embodiment energy in order to operate the light sensor is scavenged from the environment utilizing photovoltaic techniques. Other energy scavenging techniques are also possible such as mechanical vibration, heat, and electromagnetic radiation. The design of the light sensor itself employs a modular architecture such that other sensor types can be easily incorporated within the existing sensor in order to measure other environmental parameters of interest such as ozone levels, barometric pressure, ambient temperature and radioactive isotopes.

The control node receives and stores the status of the individual lights in the lighting system from the individual light sensors. The frequency by which the individual light sensors report status can be dynamically altered in real time by the control node. In the preferred embodiment the control node has the ability to report the light status record to the light Management Center through wireless communications. For redundancy purposes in large geographical areas there can be multiple control nodes each with its own logically connected light sensor set. If a particular control node experiences difficulty, the light sensors can automatically reassign themselves to other active control nodes. Some control nodes can also have incorporated a light detection sensor capability. In this case, the control node acts both as a light sensor and a control node.

The status information of the individual lights in a given lighting system is received by the light Management Center and is displayed in real time in both a geospatial context and in tabular form. Individual light repair actions to be conducted may be determined in an automatic mode or by personnel in the in the light Management Center. Field personnel are then dispatched to repair dysfunctional lights in the lighting system.

### DESCRIPTION OF THE DRAWINGS

FIG. 1 illustrates an actual street with multiple lights not turning on at night and one light continuously on for 24 hours per day.

FIG. 2 illustrates a lighting condition status reporting system via an heuristic wireless network.

FIG. 3 illustrates a light assembly with an attached light detection sensor.

FIG. 4 illustrates a typical light sensor system diagram.

FIG. 5 illustrates the logical methods by which the light detection sensor validates correct self-operation, discovers nearest neighbor light detection sensors, discovers the network communication routing and enters the polling mode.

FIG. 6 illustrates the various initialization methods by which the light detection sensor determines that all elements of the sensor are operating correctly.

FIG. 7 illustrates the method of discovery of nearby light detection sensors for incorporation into the autonomous sensor network.

FIG. 8 illustrates the method of discovery of the network communication routing employed by a light sensor in the network.

FIG. 9 illustrates an example whereby an individual light sensor establishes a network communication route.

FIG. 10 illustrates the communication protocol method employed in the heuristic light sensor network.

FIG. 11 illustrates the polling and reporting method of the various individual light sensors.

FIG. 12 illustrates the transmission method of an individual light sensor node in response to a controlling node request for status.

### DETAILED DESCRIPTION OF THE INVENTION

In a first embodiment, the invention is a street light system monitoring and real time data management system and methodology for collecting information from geographical distributed locations or individual sensor nodes dedicated to individual street lights of a multi-light street light system comprising:

an intelligent detection sensor that performs self-checking to insure reliability, availability and sustainability, has the ability to discover nearby or “neighbor” sensors, has the ability to discover and establish a wireless network communication path, has the ability to autonomously change the wireless network communication path, and has the ability to participate in a communication protocol for reporting measured conditions of a given sensor;

an intelligent sensor architecture that accommodates the ability to incorporate other sensor type;

a means for collecting information and for assigning unique space and/or time coordinates associated with said information, said information collected for immediate or subsequent transmission;

a communication network for transmitting said collected information;

a means for establishing a connection between said information collection means and said communication network and for initiating the transmission of said collected information instantly or at a selected time; said establishing means in communication with to said means collecting means;

a computer, coupled to said communication network, adapted to receive said collected information from said information collecting means and for transforming said collected information and associated space and/or time coordinates into an event description and/or other associated data; said computer adapted to store said event description and associated data in an event database and for accessing a reference database to generate an event summary that combines or updates said event description with a previously generated event summaries.

The system further comprises means for managing the distribution of resources in response to the state of the system.

The system further comprises a method for obtaining and disbursing information concerning the sensed conditions.

In an alternative embodiment, the invention is a street light monitoring system for collecting information from geographical distributed sensor nodes dedicated to individual street lights of a multi-light street light system comprising:

a plurality of intelligent detection sensors, each said sensor having means for self-checking to insure reliability, availability and sustainability, means for discovering nearby sensors, means for discovering and establishing a wireless network communication path, means for autonomously changing the wireless network communication path, and means for participating in a communication protocol for reporting measured conditions of an individual sensor;

means for collecting information and for assigning unique space and/or time coordinates associated with said information, said information being collected for immediate or subsequent transmission;

a communication network for transmitting said collected information;

a means for establishing a connection between said information collection means and said communication network and for initiating the transmission of said collected information instantly or at a selected time; said establishing means being in communication with said collecting means;

a computer, coupled to said communication network, adapted to receive said collected information from said information collecting means and for transforming said collected information and associated space and/or time coordinates into an event description and/or other associated data; said computer adapted to store said event description and associated data in an event database and for accessing a reference database to generate an event summary that combines or updates said event description with a previously generated event summaries.

In addition, such system wherein each of said sensors is dedicated to an individual street light, wherein said information comprises information as to the illumination status of each individual street light and/or wherein at least one of said sensors comprises a control node sensor, said establishing means comprising said at least one control node sensor.

In still another embodiment, the invention is a street light monitoring system comprising:

a plurality of geographically spaced individual street lights;

a plurality of light monitoring sensor nodes, wherein one said sensor node is associated with one said street light, each said sensor node detecting the illumination status of the associated street light;

each said sensor node capable of wirelessly communicating with at least one other of said sensor nodes;

at least one of said sensor nodes comprising a control node, wherein said control node is capable of wirelessly communicating with a remote lighting control and management system;

wherein said sensor nodes and said at least one control node are capable of determining the optimum communication path through multiple said sensor nodes from any one said sensor node to said at least one control node, and wherein said sensor nodes and said at least on control node are capable of determining alternative communication paths from any sensor node to said at least on control node in the event said optimum communication pathway fails.

In addition, such system wherein said sensor nodes are physically mounted onto said street lights, wherein said sensor nodes comprise a fiber optic cable and a photosensor, wherein said remote lighting control and management system comprises a computer, and/or wherein each said sensor node further comprises a solar photovoltaic panel to provide power to said sensor node.

In the following description of the preferred embodiment, reference is made to the accompanying drawings that form a part hereof, and in which shown by way of illustration a specific embodiment in which the invention may be practiced. It is to be understood that other embodiments may be utilized and that changes maybe made without departing from the scope of the present invention. For purposes of illustration, the following description describes the present invention as used with particular light sensors in conjunction with web-server computers and web-browser computers coupled to the Internet. However, it is contemplated that the present invention can also be used as part of a computer system coupled to private or public networks such as radio or telephone networks. Reference will now be made in detail to the preferred embodiments of the invention, examples of which are illustrated in the accompanying drawings.

### System Description

Referring now to FIG. 1, the status of a representative street lighting system 100 is shown. In this example, approximately 40% of the individual street lights 10 fail to turn on at dusk and one street light 10 is continuously on 24 hours per day, the term “street light” referring to the street light assembly comprising a lamp 11 and a housing 12. The street lights 10 are provided with power, typically through an electrical grid, but also possibly through solar power generating devices, and are typically mounted onto a pole. Due to the operational expense of conducting periodic field surveys of individual street light 10 status many operators of lighting systems 100 avoid frequent field inspections of individual street light 10 status resulting in possible impacts to safety and security conditions.

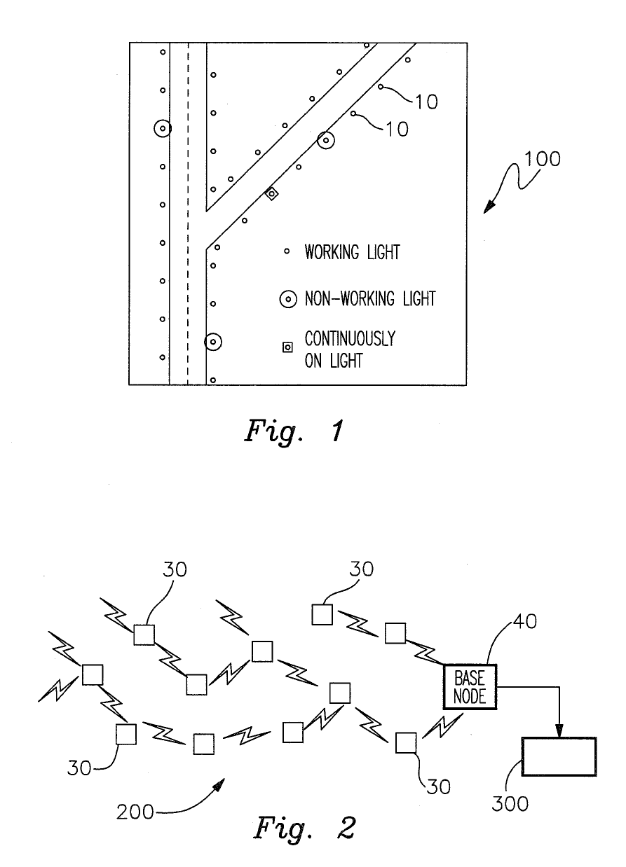

Referring now to FIG. 2, an example of the lighting condition network status reporting system 200 is shown in greater detail. Individual light detection sensor nodes 30 are mechanically attached to each individual street light 10 in the lighting system 100. The light monitoring sensor nodes 30 operate independently from the street lighting system 100 electrical infrastructure. The light monitoring sensor nodes 30 form an heuristic wireless network for reporting individual light 10 status. The individual light 10 status information is reported to a control node 40 via wireless communication techniques. The control node 40 updates and retains a local database on the individual light 10 status and transmits this database status information to a light management control system 300. The preferred embodiment of the control node 40 method of communicating to the light management control system 300 is via wireless communication techniques. Other methods of communication may also be employed. The control node 40 may also include the light detection status capability if attached to a street light assembly 10.

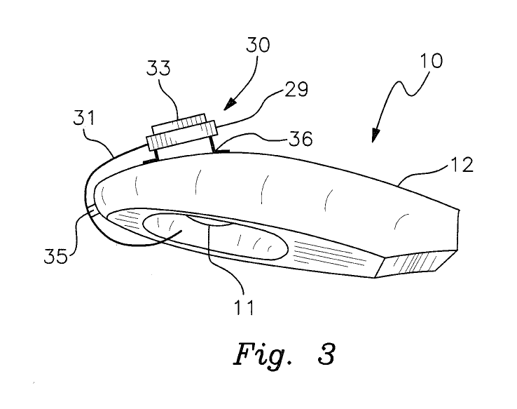

Referring now to FIG. 3, a light detection sensor node 30 is shown physically attached to a light assembly 10. A fiber optic cable 31 is secured on the housing 29 by a mount 35 and is utilized to capture and transport light to a photodiode or other photosensor 32 which generates a voltage signal whose magnitude is proportional to the amount of light received. Thus, the light sensor node 30 can detect when a light 10 is not on at night as well as when a light 10 is on during day light hours. In addition, in the preferred embodiment the light detection sensor node 30 utilizes photovoltaic solar cells 33 to provide electrical energy for the light detection sensor 30. Alternative forms of energy scavenging from the environment may also be used such as heat, vibration or electromagnetic radiation.

The components comprising the light detection sensor node 30 are encased within a durable, rugged, low profile, waterproof, environmentally suitable housing 29, with the fiber optic cable 31 extending from the housing 29 and mounted to the street light assembly 10 such that its distal end is positioned to receive light directly from the lamp 11 of the street light 10. the housing 29 is preferably mounted with supports 36 in a manner providing a separation distance or gap between the housing 29 and street light housing 12 to provide for increased heat dissipation. Preferably the operational components of the light sensor node 30 are readily replaceable, and may be provided as an assembled unit that slides into and out of the housing 29. The housing 29 is preferably bonded to the street light housing 12 for efficient installation, but the housing 29 may be attached by mechanical fasteners, welding or any other suitable method.

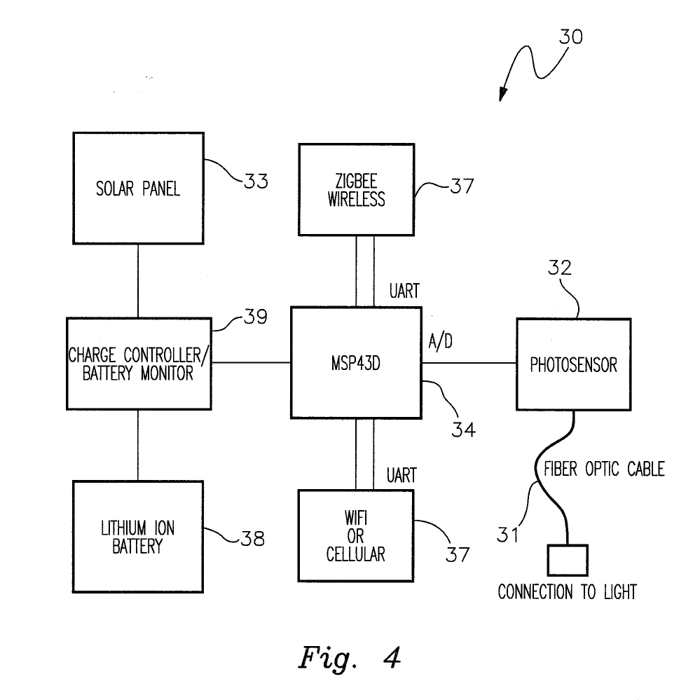

Referring now to FIG. 4, the system diagram of the light detection sensor 30 is shown. The light sensor node 30 is composed of a central processing unit (CPU) 34 for processing information and controlling the light sensor 30 operation, such as for example a TI MSP430F449 microprocessor comprising a memory (MEM) or storing programs and data, an analog to digital converter (A/D) for transforming a voltage signal into a digital value, a photodiode (PDI) 32 for sensing the amount of incoming light and converting to a corresponding voltage signal, a radio frequency transceiver (RFT) 37 for communicating within the heuristic sensor network 200, preferably possessing a communications range of approximately 200-400 feet, a solar photovoltaic panel (SPP) 33 for the conversion of solar radiation into electrical energy, a battery (BAT) 38 for the storage of electrical energy, preferably rechargeable, and a charger controller (CCT) 39 for managing the charging of the battery with electrical energy form the solar photovoltaic panel.

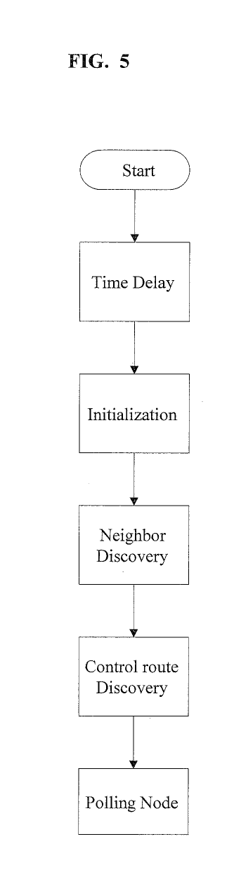

FIG. 5 provides a flow chart illustrating the light sensor 30 set of methods, initialization, neighbor discovery, network communication route discovery and polling for status information.

### Initialization Method

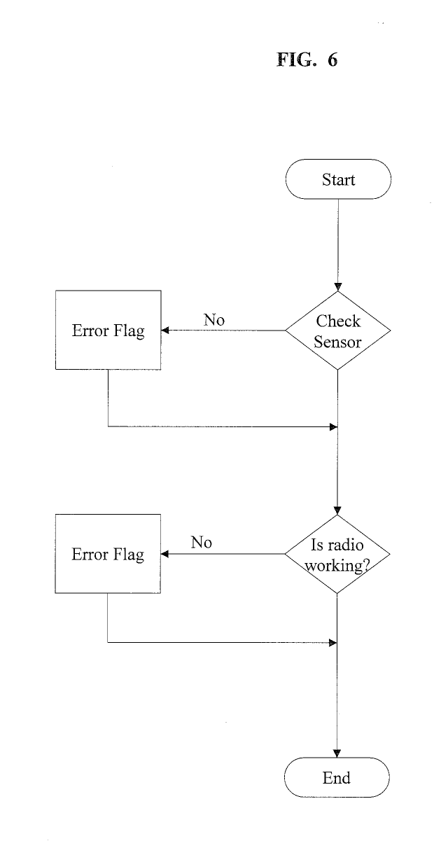

Referring now to FIG. 6, the program logic for the Initialization Method is shown. The light sensor 30 has built in error detection, isolation and reporting mechanisms incorporated in the circuits and program code. After power and a sensor reset, each of the sensor components is tested for valid functioning. Other diagnostic tests include processor data paths, memory and power status. The result of each component test is recorded in the Sensor Status Word. The Sensor Status Word is available to the control node 40 upon request. If an error state is detected, the Sensor Status Word is transmitted automatically to the control node 40.

### Neighbor Discovery Method

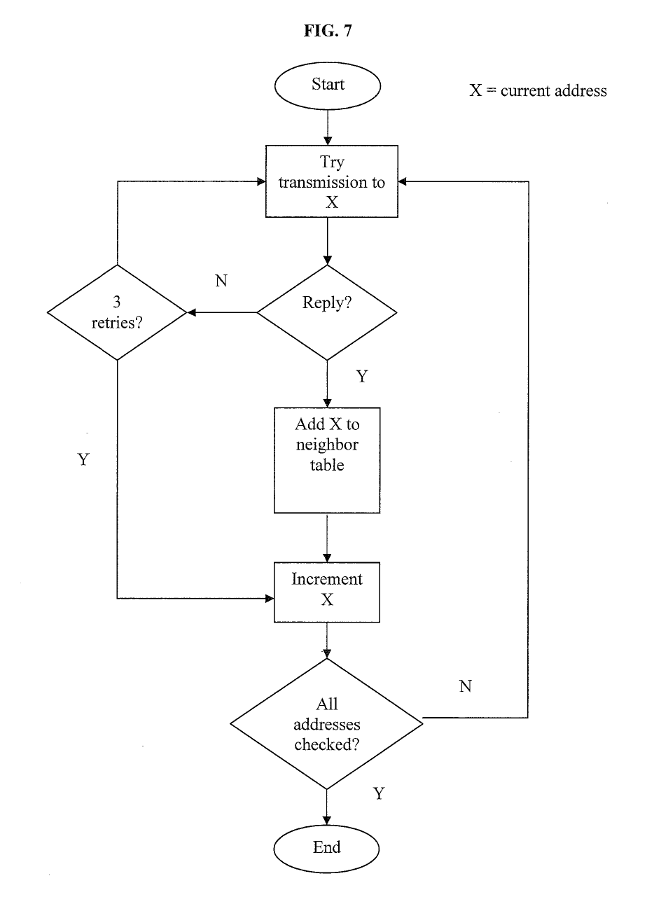

The purpose of the neighbor discovery method, as shown in FIG. 7, is to identify and record all light sensor nodes 30 in the vicinity of a light sensor node 30 that has just been powered on. Having successfully completed the initialization method, the light sensor 30 broadcasts a request id command (REQID). All light sensor nodes 30 in the vicinity of the light sensor 30 issuing the REQID respond with an acknowledge id (ACKID). The acknowledgement includes the id of the responding light sensor node 30. The id of the responding light sensor neighbor 30 along with the signal strength of the received transmission is recorded in the neighbor id table of the light sensor 30 that issued the request id command. As other neighbor light sensor nodes 30 respond, their id and received signal strength are also recorded in the neighbor id table. The neighbor table is organized such that the neighbor light sensor 30 with the strongest received signal strength is placed first in the neighbor id table. The neighbor light sensor 30 responding to the request id command with the second strongest received transmission signal is placed second in the neighbor id table and so on until all responding neighbor light sensors 30 have responded.

The light sensor nodes 30 responding to the new light sensor node 30 request for id also record to their respective neighbor id table the id of the new light sensor node 30 and the signal strength of the received signal transmission. The new light sensor 30 id and signal strength value are placed into the neighbor id table in accord with the received signal strength.

Each neighbor light sensor node 30 responding to the request id command receives an acknowledgement (ACKR) from the new light sensor node 30. Thus, the neighbor discovery inquiry has been successfully concluded between the new light sensor node 30 and the responding light sensor node 30. If no acknowledgement is received from the new light sensor node 30, the neighbor sensor node 30 enters into an error recovery mode by retransmitting its id acknowledgement another three times spread over various time intervals between each acknowledge id response. Thus, all neighbor light sensor nodes 30 have the ability to integrate the new light sensor node 30 into id and signal strength into their respective neighbor id table. If no acknowledgement is received from the new light sensor node 30, an appropriate error flag is set into the neighbor light sensor node 30 status table.

### Communication Route Discovery Method

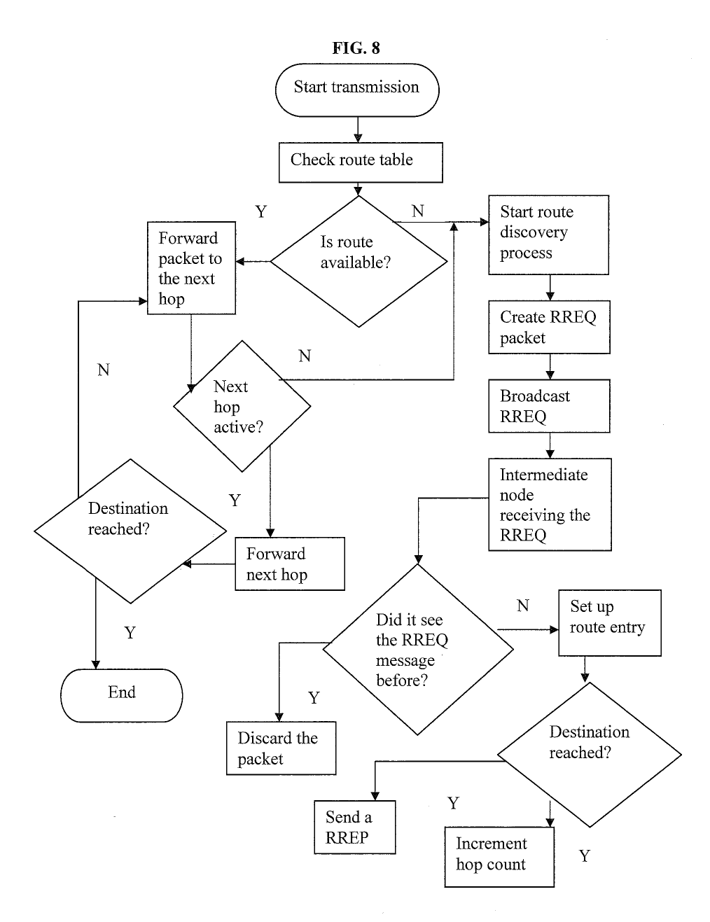

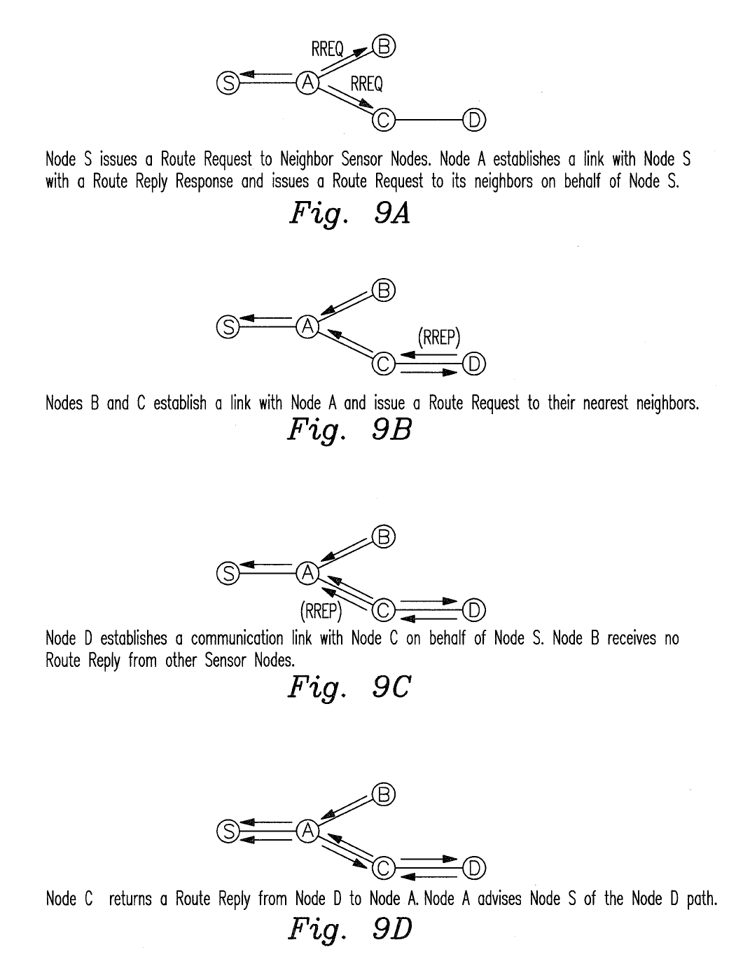

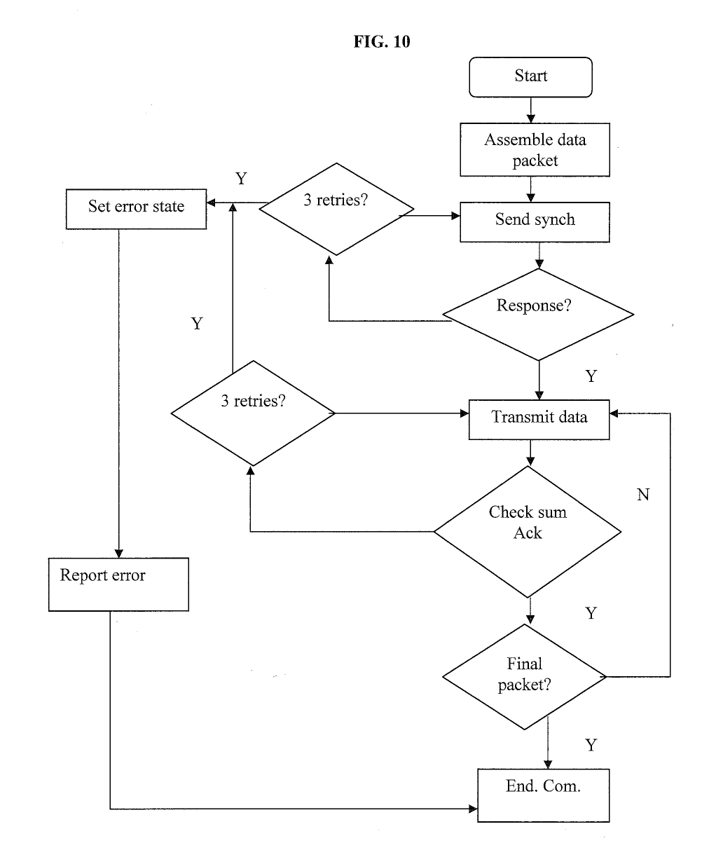

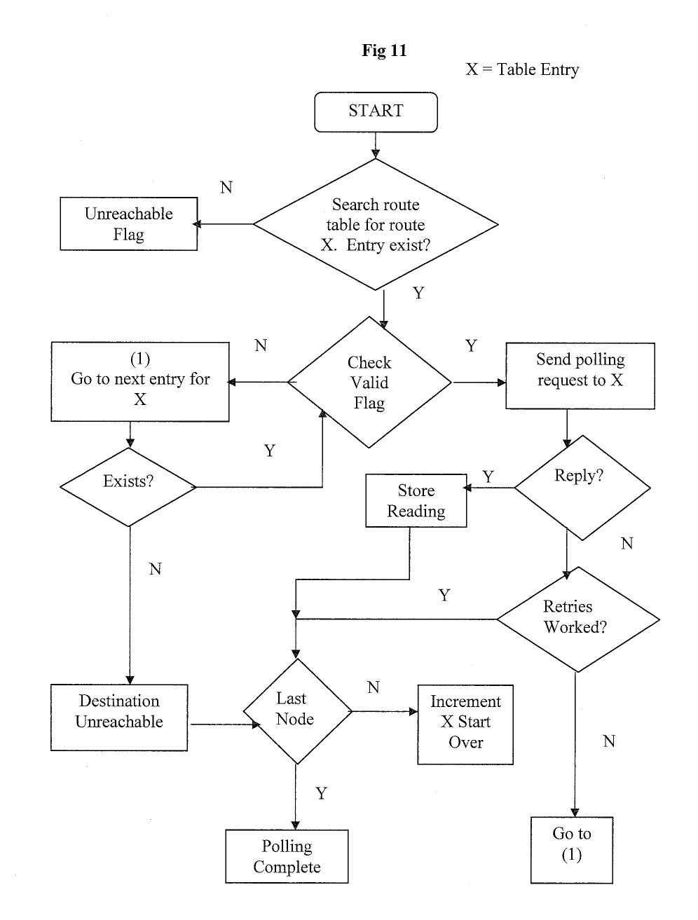

The logic flow of the micro-program along with the sequence of states for the wireless Communication Route Discovery method is shown FIG. 8 and FIG. 9 respectively. A new light sensor 30 introduced into the network 200 broadcasts a Route Request (RREQ) command to its nearest neighbors 30 in order to initiate the process to establish a communication route to a control node 40. Neighbor sensor nodes 30 receiving the Route Request broadcast for the new sensor 30 respond with a Route Reply (RREP). The response from neighbor sensor nodes 30 is logged into a table along with their associated signal strength. The new sensor node 30 selects its desired neighbor node 30 for its communication path with the strongest signal strength. The selected node 30 is advised of the selection and in turn issues a Route Request command to its neighbors 30 on behalf of the new sensor 30. The new sensor node 30 is advised of the next communication node 30 in the path. This process continues until a control node 40 responds to the new sensor communication route discovery method. At this point, a viable communications route has been established between a control node 40 and the new sensor 30 introduced into the network 200.

If a particular communication route becomes non-functional for some reason between a sensor(s) 30 and a control node 40, the impacted sensor(s) 30 initiates the communication route discovery method once again. In this case, many of the communication nodes along a path are already known due to the first communication route discovery method process. The process is repeated until the sensor 30 once again has a logical connection to a control node 40. The network 200 is heuristic and self healing.

### Polling and Transmission Methods

The control node 40 will issue a periodic request for light sensor status to those light sensor nodes 30 contained in the control node's 40 route table. The control node 40 begins with the first light sensor node 30 in the table and requests current light sensor status. Once the information is received and stored in the control node 40 memory, the control node 40 proceeds to the second light sensor node 30 in the control node's 40 route table. The same process of gathering the light sensor node 30 status is repeated. This sequential polling between the control node 40 and the light sensor nodes 30 is continued until the current status of the lights 10 contained in the route table is collected. Once all the status is collected, the control node 40 then transmits the information to the Light Control Management System Center 300.

If a light sensor node 30 does not respond to the control node 40 poll, a retry procedure is activated. If this fails, then the non-responding light sensor node 30 trouble status is recorded and is also transmitted to the Light Control Management Center 300. Neighboring nodes 30 to the light sensor node 30 not responding are instructed by the control node 40 to restructure their communication paths with their other nearest neighbors 30 n order to reestablish the network communication links.

The transmit method is how the light sensor node 30 transmits requested status information to the control node 40. The light sensor node 30 desiring to transmit light sensor 30 status begins by assembling the information to be sent in a set of data packets. Once assembled, the light sensor 30 sends out a synchronous request to the predefined light sensor 30 in the neighbor table. Once acknowledged, the light sensor 30 then proceeds to send a sequential set of data packets until the all information requested is transmitted. The data packet transmissions are protected by a check sum technique to detect an error in transmission. If an error state is detected. A request for retransmission is issued. This is done a number of times before an error state is recorded. A similar retry process is utilized on the synchronous request and the transmit packet(s) transactions if an error is detected. This transmit method is followed until the requested status information has completed transmission by the light status sensor node 30 being queried by the associated control node 40.

### Operation of the System

The operation of the light sensor nodes 30 and associated control nodes 40 is autonomous once installed. On the initial installation of the various light sensor nodes 30 and the control nodes 40, the geospatial position of the individual street light 10 and the logical address of the associated sensor 30 or control node 40 must be entered into a master table in the Management Control Light Center 300. This information permits the GIS application to record and display the individual light 10 status information in real time. Personnel in the Light Control Management Center 300 may now dispatch field repair actions per economic, safety and security considerations. This may also be done by automatic methods in the GIS application.

It is understood that equivalents and substitutions for certain elements described above may be obvious to one of ordinary skill in the art, and therefore the true scope and definition of the invention is to be as set forth in the following claims.

We claim:

1. A street light monitoring system comprising:
a plurality of geographically spaced individual street lights;
a plurality of light monitoring sensor nodes, wherein one said sensor node is associated with one said street light, each said sensor node detecting the illumination status of the associated street light;
each said sensor node capable of wirelessly communicating with at least one other of said sensor nodes;
at least one of said sensor nodes comprising a control node, wherein said control node is capable of wirelessly communicating with a remote lighting control and management system;
wherein said sensor nodes and said at least one control node are capable of determining the optimum communication path through multiple said sensor nodes from any one said sensor node to said at least one control node, and wherein said sensor nodes and said at least on control node are capable of determining alternative communication paths from any sensor node to said at least on control node in the event said optimum communication pathway fails.

2. The system of claim 1, wherein said sensor nodes are physically mounted onto said street lights.

3. The system of claim 1, wherein said sensor nodes comprise a fiber optic cable and a photosensor.

4. The system of claim 2, wherein said sensor nodes comprise a fiber optic cable and a photosensor.

5. The system of claim 1, wherein said remote lighting control and management system comprises a computer.

6. The system of claim 1, each said sensor node further comprising a solar photovoltaic panel to provide power to said sensor node.

7. A street light monitoring system for collecting information from geographical distributed sensor nodes dedicated to individual street lights of a multi-light street light system comprising:
a plurality of intelligent detection sensors, each said sensor having means for self-checking to insure reliability, availability and sustainability, means for discovering nearby sensors, means for discovering and establishing a wireless network communication path, means for autonomously changing the wireless network communication path, and means for participating in a communication protocol for reporting measured conditions of an individual sensor;
means for collecting information and for assigning unique space and/or time coordinates associated with said information, said information being collected for immediate or subsequent transmission;
a communication network for transmitting said collected information;
a means for establishing a connection between said information collection means and said communication network and for initiating the transmission of said collected information instantly or at a selected time; said establishing means being in communication with said collecting means;
a computer, coupled to said communication network, adapted to receive said collected information from said information collecting means and for transforming said collected information and associated space and/or time coordinates into an event description and/or other associated data; said computer adapted to store said event description and associated data in an event database and for accessing a reference database to generate an event summary that combines or updates said event description with a previously generated event summaries.

8. The system of claim 7, wherein each of said sensors is dedicated to an individual street light.

9. The system of claim 8, wherein said information comprises information as to the illumination status of each individual street light.

10. The system of claim 7, wherein at least one of said sensors comprises a control node sensor, said establishing means comprising said at least one control node sensor.
